(19) United States
(12) Patent Application Publication
(10) Pub. No.: US 2023/0348755 A1
(43) Pub. Date: Nov. 2, 2023

(54) METHOD OF BLENDING ADHESIVE COMPONENTS AT THE JOB SITE FOR ROOFING APPLICATIONS

(71) Applicant: JOHNS MANVILLE, Denver, CO (US)

(72) Inventors: Jordan Kortmeyer, Parker, CO (US); Jonas Houchin, Centennial, CO (US)

(21) Appl. No.: 17/731,066

(22) Filed: Apr. 27, 2022

(51) Int. Cl. C09J 5/00; C09J 11/04; C09J 11/08

(52) U.S. Cl. CPC C09J 5/00; C09J 11/04; C09J 11/08

(57) ABSTRACT

A method for preparing an adhesive at a jobsite may include introducing a pre-packaged quantity of adhesive additive components to a volume of a solvent. The method may include introducing a pre-packaged quantity of adhesive filler components to the volume of the solvent. The method may include mixing the volume of the solvent to disperse the adhesive additive components and the adhesive filler components within the volume of the solvent to produce an adhesive.

### BACKGROUND OF THE INVENTION

Roofing adhesives are often utilized to secure roofing membranes to roofing boards and/or other roofing structures. Conventional roofing adhesives are pre-mixed at a factory and supplied to job sites in large vessels, such as buckets and drums. However, due to the time that passes between packaging using the roofing adhesives, as well as the environmental conditions during transport of the roofing adhesive from the factory to the job site, many problems may arise with the roofing adhesives. For example, additives within the roofing adhesives may settle out of solution over time, which either necessitates the remixing of the roofing adhesive and/or may prevent the roofing adhesive from being in optimum condition at the time of use. Additionally, some roofing adhesives (particularly water-based roofing adhesives) may be sensitive to temperature, which may make it more difficult to ship such roofing adhesives in certain climates. For example, the integrity of some roofing adhesives may be diminished if the roofing adhesive freezes during transport. In some roofing adhesives, additional mixing at the job site may revive the roofing adhesive, however some roofing adhesives (such as many water-based adhesives) may irreparably break down if the roofing adhesive freezes. Additionally, pre-mixed adhesives are heavy and take up significant amounts of space, which increases the costs associated with shipping the adhesives. Therefore, improvements in roofing adhesives are desired.

### BRIEF SUMMARY OF THE INVENTION

Some embodiments of the present technology may encompass methods for preparing an adhesive at a jobsite. The methods may include introducing a pre-packaged quantity of adhesive additive components to a volume of a solvent. The methods may include introducing a pre-packaged quantity of adhesive filler components to the volume of the solvent. The methods may include mixing the volume of the solvent to disperse the adhesive additive components and the adhesive filler components within the volume of the solvent to produce an adhesive.

In some embodiments, the methods may include after mixing the volume of the solvent, adding a letdown portion of the solvent to the adhesive to adjust a viscosity of the adhesive. The methods may include mixing the volume of the solvent after introducing the packaged quantity of adhesive additive components and prior to introducing the pre-packaged quantity of adhesive filler components. The adhesive additive components may be provided in a first container. The adhesive filler components may be provided in a second container. One or both of the first container and the second container may be dissolvible in the solvent such that introduction of one or both of the adhesive additive components and the adhesive filler components into the volume of the solvent may include placing the respective container into the volume of the solvent. The solvent may include at least one solvent selected from the group consisting of water, acetone, an alcohol, and a alkyl-based solvent. The adhesive additive components may include at least one additive selected from the group consisting of a dispersant, a flocculant, a colorant, and a resin. The adhesive filler components may include at least one filler selected from the group consisting of calcium carbonate, mica, and talc.

Some embodiments of the present technology may encompass methods for preparing an adhesive at a jobsite. The methods may include measuring out a volume of water into a mixing vessel. The methods may include introducing a pre-packaged quantity of adhesive additive components to the mixing vessel. The methods may include introducing a pre-packaged quantity of adhesive filler components to the mixing vessel. The methods may include mixing the water, the adhesive additive components, and the adhesive filler components to disperse the adhesive additive components and the adhesive filler components within the volume of water to produce an adhesive.

In some embodiments, the mixing may be done using a stir stick or a stirring attachment for a drill. The mixing vessel may include a bucket or a drum. The pre-packaged quantity of adhesive additive components may be introduced to the mixing vessel prior to the pre-packaged quantity of adhesive filler components. The pre-packaged quantity of adhesive additive components and the pre-packaged quantity of adhesive filler components may be packaged in a single container. The single container may include a partition that separates the pre-packaged quantity of adhesive additive components from the pre-packaged quantity of adhesive filler components until the pre-packaged quantity of adhesive additive components and the pre-packaged quantity of adhesive filler components are introduced to the mixing vessel. The pre-packaged quantity of adhesive additive components and the pre-packaged quantity of adhesive filler components may be pre-measured such that one package of the pre-packaged quantity of adhesive additive components and one package of the pre-packaged quantity of adhesive filler components are used to form one mixing vessel of the adhesive. Introducing the pre-packaged quantity of adhesive filler components to the mixing vessel may include sequentially introducing a plurality of portions of the pre-packaged quantity of adhesive filler components to the mixing vessel.

Some embodiments of the present technology may encompass adhesive kits. The kits may include one or more containers that include a pre-packaged quantity of adhesive additive components and a pre-packaged quantity of adhesive filler components. The adhesive additive components may include at least one additive selected from the group consisting of a dispersant, a flocculant, a colorant, and a resin.

The adhesive filler components may include at least one mineral-based filler. The kits may include a mixing vessel that houses the one or more containers. The kits may include a pre-measured quantity of a solvent. The one or more containers may include a first container that contains the pre-packaged quantity of adhesive additive components and a second container that contains the pre-packaged quantity of adhesive filler components. The one or more containers may include a single container. The single container may include a partition that separates the pre-packaged quantity of adhesive additive components from the pre-packaged quantity of adhesive filler components until an adhesive formed using the pre-packaged quantity of adhesive additive components and the pre-packaged quantity of adhesive filler components. At least one of the one or more containers may be dissolvible in a solvent used to produce an adhesive.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a bituminous roofing membrane according to embodiments of the present invention.

FIG. 2 illustrates a system for producing a liquid adhesive at a jobsite according to embodiments of the present invention.

FIG. 3 is a flowchart illustrating a process for producing a liquid adhesive at a jobsite according to embodiments of the present invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to techniques for packing and shipping components for adhesive materials that may be mixed to form a liquid adhesive at a jobsite. In particular, embodiments are directed to adhesives that are used to secure a roofing membrane to an underlying roof structure. As used herein, the term roofing membrane means essentially any material that is installed atop a roof, typically as an outer surface or layer. Such roofing membranes are commonly installed for various functional and/or aesthetic purposes. For example, roofing membranes may be installed to provide weather proofing, reduce urban heat island effects via heat reflection, reduce UV damage, reduce roof maintenance and/or degradation, improving weathering characteristics, and the like. Roofing membranes may also provide a sleek and/or desired roof appearance, such as a uniform roof color and/or style. While discussed primarily in the context of adhesives for adhering roofing membranes to underlying roofing structures, it will be appreciated that the present invention is not so limited, and that the adhesive materials and techniques described herein may be utilized in any other adhesive application.

Embodiments may include premeasured quantities of various adhesive components, which may be introduced to a predetermined quantity of a solvent and mixed to form an adhesive. In some embodiments, a kit may be provided that may include all of the ingredients of the final liquid adhesive other than the solvent. For example, pouches or other containers of adhesive components may be provided in a mixing container, such as a drum or bucket, and shipped to a jobsite. When needed, a solvent may be measured into the mixing container, and the adhesive components added and mixed within the solvent to produce a liquid adhesive that may be applied during installation of a roofing membrane. By packaging and shipping the adhesive materials in unmixed form (e.g., without the solvent), several benefits may be realized. For example, the solvent may be sourced locally proximate the job site (such as from a water source and/or local solvent supplier), which may reduce the space and weight requirements for storing and shipping the adhesive prior to use. Additionally, as the adhesives are not premixed, the components are less susceptible to issues associated with low temperatures, such as freezing/chunking, which may ruin the adhesive and/or require remixing of the adhesive prior to installation. Mixing the adhesive at the jobsite may also prevent the adhesive components from having time to settle out of solution, which may improve the uniformity and effectiveness of the liquid adhesive. Additionally, as the components are provided in premeasured quantities, the components may be quickly and easily combined to create consistent batches of liquid adhesive as needed. In some embodiments, multiple batches of un-mixed components may be provided in a single mixing container, which may enable the mixing container to be reused to mix multiple batches of adhesive, which may cut down on waste and storage space.

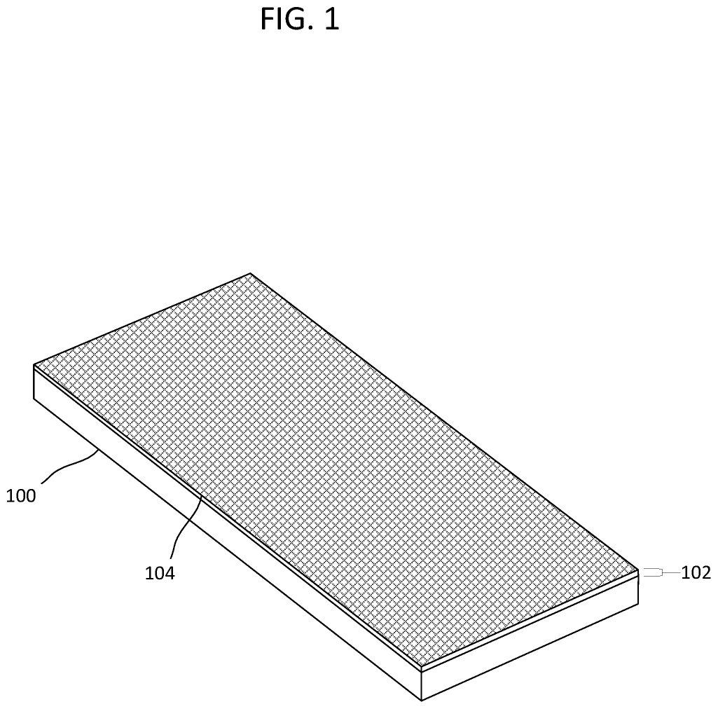

Turning now to FIG. 1, a roof structure 100 that is covered with a roofing membrane 102 is illustrated. The roof structure 100 may be formed atop all or part of a building and/or other structure and may be generally flat and/or pitched. Roof structure 100 may include any number of materials and/or layers in addition to the roofing membrane 102. These layers/materials are typically positioned under the roofing membrane 102 and may include support members (e.g., wood and/or metal beams), insulation layers (e.g., foam and/or other insulating boards), and/or other boards or members. The roofing membrane may be coupled with one or more of these materials via ballasting, mechanical fastening, adhesive bonding, induction welding, heat welding, and the like.

Roofing membrane 102 may be positioned atop roof structure 100, oftentimes above an insulation layer, and may be configured to prevent leaks in the roofing structure 100 and/or to provide aesthetic appeal. Typically, the roofing membrane 102 is in the form of a single ply membrane. The term “single-ply” is used to describe a roof structure 100 having a single application of a roofing membrane 102, but the roofing membrane 102 itself may include multiple layers. For example, the roofing membrane 102 may include polymer layers, reinforcing layers, adhesive layers, coatings, a fleece layer, and the like. It will be appreciated that in some embodiments, multiple layers of roofing membrane 102 may be applied to a single roof structure 100.

Oftentimes, the roofing membrane 102 is provided as a roll of flat, flexible membrane that may be rolled out on top of the roof structure 100. For example, a single ply roofing membrane 102 may be supplied in any workable size (such as, but not limited to, rolls of 10 feet wide or more and containing 100 linear feet or more of roofing membrane 102). The roofing membrane 102 may be adhered to the roof structure 100 using an adhesive, such as those described herein. Oftentimes, the roof structure 100 is too large to be covered by a single piece of roofing membrane 102. In such instances, multiple pieces of roofing membrane 102 may be overlapped and joined at the seams using a waterproof joining method. For example, seams of adjacent pieces of roofing membrane 102 may be joined by priming and/or preparing edges of the roofing membranes 102 and then applying a tape to the primed and/or prepared edges, using heat welding and/or using another form of adhesive bonding. In priming or preparing the edges, the installer must wait for the primer material to flash before applying the adhesive. Improper application of the primer and/or adhesive may result in an improper bond, which may create immediate and/or long term roofing problems, such as leakage. Examples of using and installing single ply roofing membranes 102 may be found in U.S. Patent Publication No. 2016/0362894, entitled “Sheet Roofing with Pre-Taped Seams and Tape Therefor” and filed Aug. 25, 2016, the entire contents of which is hereby incorporated by reference for all purposes.

In accordance with the present invention, the roofing membrane 102 includes a waterproofing layer 104. The waterproofing layer 104 is configured to form the outer layer of the roof once fully installed, and helps prevent leaks in the roofing structure 100 and provides aesthetic appeal to the finished roof. For example, the waterproofing layer often provides a uniform outer surface that provides an aesthetically pleasing finished appearance to the roof. Waterproofing layer 104 may have a white exterior, but may be made in various other colors or shades, such as grey, tan, black, and the like. White waterproofing layers 104 are often used to provide a pleasing appeal to the building and/or to reflect radiation and thereby minimize heat island effects. In other embodiments, a black or other dark waterproofing layer 102 may be provided. Such waterproofing layers 104 absorb more radiant heat than white waterproofing layers 104. Additionally, in the winter, condensation evaporates quicker and snow and ice melt more rapidly on black roofs than white roofs.

In some embodiments, waterproofing layer 104 may be formed of various synthetic rubber materials, modified bitumen, or thermoplastic materials. For example, roofing membrane 102 may commonly include thermoplastic polyolefin (TPO), polyvinyl chloride (PVC), ethylene propylene diene monomer (EPDM), chlorinated polyethylene (CPA), and/or modified bitumen, although some embodiments may use other thermoset and/or thermoplastic roofing membranes. In some embodiments, the waterproofing layer 104 may include one or more polymers blended with one or more fillers. For example, in some embodiments the waterproofing layer 104 may include some combination of the following materials: polypropylene, polyethylene, block copolymer polypropylene, rubber, plasticizers, fiberglass, carbon fiber, fire retardants, and the like. In another embodiment, a waterproofing layer 104 may have a more pure polymer blend without or with very few fillers. For example, the waterproofing layer 104 may include mainly polypropylene or polyethylene or some combination of these polymers with little to no fillers, although in some embodiments, these waterproofing layer 104 may include some amount of a filler, such as a fire retardant.

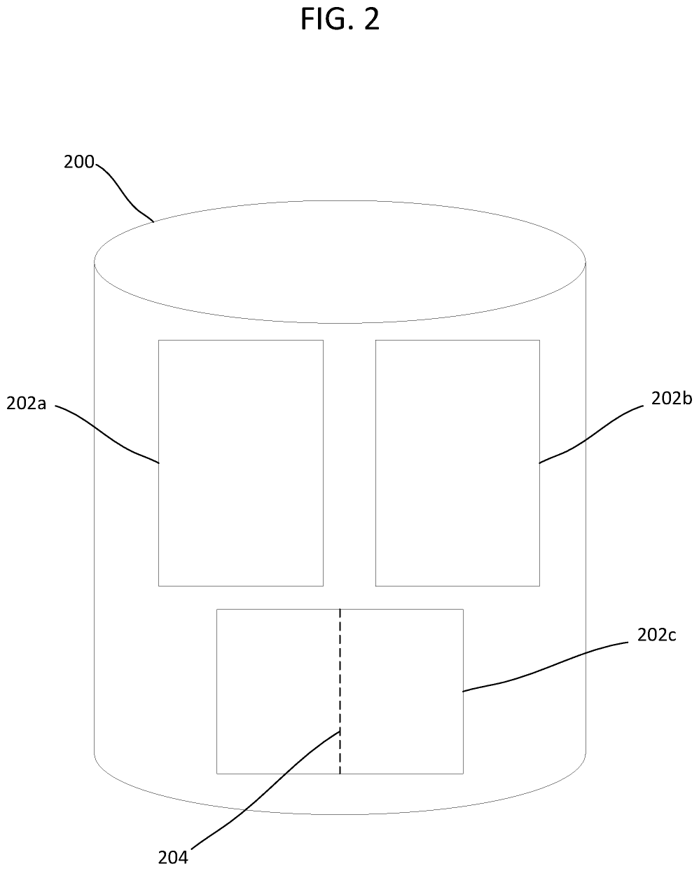

FIG. 2 illustrates a kit or system for mixing a liquid adhesive at a jobsite in accordance with embodiments of the present invention. The liquid adhesive may include a solvent, additive components, and filler components. The solvent may include water, xylene, acetone, alcohol and/or alkyl-based, and/or other water-based solvents. The additive components may include resins (such as but not limited to acrylic resins), tackifiers, dispersants, colorants, flocculants, coalescing agents, other additives, and/or combinations thereof. Suitable tackifiers may include UNI TAC 70, AQUATAC 2600. Suitable dispersants may include EFKA FA 4644 and DISPEX ULTRA FA 4420. Suitable colorants may include P95015 Chromatint® Blue 3115 Dispersion. Suitable acrylic resins that may be used include Acrynax 11588 and/or Acrynax 11891 from Franklin Adhesives and Polymers. Additional examples of suitable acrylic resins may include Vinnapas UW 25FS and/or Vinnapas B/500/40 VL from Wacker Chemie AG. Suitable tackifiers may include Dymerex or Foral AX-E from Eastman Rosin Products. Filler components may include mineral-based fillers, such as calcium carbonate, mica, talc, and/or other filler materials. In a particular embodiment, the adhesive may include between about 45% and 60% by weight of a resin, between about 2% and 5% by weight of surfactants and/or other additives, between about 2% and 9% by weight of filler components, and between about 26% and 51% by weight of solvent, although other embodiments may include different quantities of one or more adhesive components.

The system may include a mixing vessel 200, such as a bucket, barrel, and/or other container that is sufficiently large to hold one or more batches of liquid adhesive. The mixing vessel 200 may be any shape and size, and may be formed from a non-reactive material, such as a polymer and/or metal. The kit may also include one more containers 202 that include pre-measured quantities of adhesive components, such as additive components and/or filler components. The containers 202 may be cans, bags, pouches, buckets, and/or any other type of sealable container. In some embodiments, all of the pre-measured adhesive components may be provided within a single container 202. For example, the components may be mixed together in a single bag, can, and/or other container 202. In some embodiments, a container 202c may include one or more partitions 204 that may separate different components of the adhesive. For example, the partition 204 may separate additive components from filler components. In other embodiments, some or all of the different components may be provided in different containers 202. For example, as illustrated, the additive components are provided in a first container 202a and the filler materials are provided in a second container 202b. It will be appreciated that any number of containers 202 may be used to separate the premeasured quantities of components in various embodiments. In some embodiments, each container 202 may include a premeasured quantity of a given adhesive component (or combination of adhesive components) sufficient to produce one batch (such as one mixing vessel worth) of liquid adhesive. This may enable a user to place one of each unique container 202 in the mixing vessel 200 to produce a batch of liquid adhesive. In some instances, such as those in which sufficient containers 202 of adhesive components are provided to make multiple batches of adhesive, a separate container 202 may be provided that contains each of the containers 202 that include different components/ingredients necessary to make a single batch of liquid adhesive.

In some embodiments, some or all of the containers 202 may be dissolvible in the solvent that is used to produce the liquid adhesive. In such embodiments, a user may place the container 202 itself into the solvent to combine the packaged adhesive components with the solvent. The dissolvable container 202 may be made from various materials, which may depend on the components stored within the container 202 and/or on the type of solvent used. For example, the dissolvable container 202 may be formed from cellulose, an acrylic, and/or thermoplastic material. In a particular embodiment, the dissolvable container 202 may be formed from a water (or other solvent) dissolvable polymer, such as (but not limited to) polyvinyl alcohol, polyethylene glycol, polyacrylamides, and/or polyacrylic acid copolymer. In some embodiments, only some containers 202 for a particular adhesive may be formed from dissolvable materials, while other containers 202 are not dissolvable. For example, the filler components may be placed in a dissolvable container 202 while the additive components may be packaged in a container 202 that is not dissolvable in the solvent. For non-dissolvable containers 202, the users may open the containers 202 and pour the contents of the containers 202 into the mixing vessel 200 when producing the liquid adhesive. The empty containers 202 may then be discarded, reused, and/or recycled.

In some embodiments, the containers 202 may be packaged inside of the mixing vessel 200 for storage and/or transport to the jobsite. For example, the mixing vessel 200 may include one or more containers 202 stored therein (oftentimes with a lid affixed to a top of the mixing vessel 200 to keep the containers 202 in place), with the containers 202 within the mixing vessel 200 together including all of the adhesive components (aside from the solvent) needed to produce a liquid adhesive at a jobsite. In some embodiments, each mixing vessel 200 may include only a number of containers 202 to produce a single batch of liquid adhesive, while in other embodiments a mixing vessel 200 may include enough containers 202 to produce a number of batches of liquid adhesive. As noted above, when sufficient containers 202 of adhesive components are provided to make multiple batches of adhesive, a separate larger container 202 may be provided that bundles each of the containers 202 necessary to make a single batch of liquid adhesive into a readily identifiable group, which may help ensure that users include all necessary adhesive components in each batch of liquid adhesive.

To produce the liquid adhesive, a user may remove the containers 202 from the mixing vessel 200 and pour a predetermined and/or premeasured volume of solvent into the mixing vessel 200. For example, the user may measure out a necessary volume of solvent and/or pour the contents of a premeasured volume of solvent into the mixing vessel 200. The user may then empty the contents of the container(s) 202 that include the adhesive additive components (and filler components in some embodiments, such as but not limited to those embodiments in which the additive components and filler components are provided in a single container 202). In embodiments in which the relevant container(s) are dissolvable in the solvent, the container(s) may be placed into the solvent without opening the container 202. The solvent and additive components may be mixed, such as using a mixing blade and drill, shaking, and/or hand mixing with a stir stick. If not already added, the filler components may be added to the mixed solution, which may be mixed again. The liquid adhesive may then be applied to secure a roofing membrane to a roof structure, such as by roll coating, spray coating, and/or otherwise applying the adhesive.

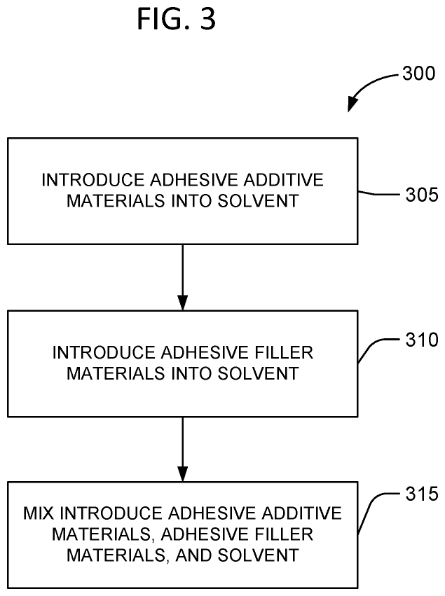

FIG. 3 is a flowchart illustrating a process 300 for preparing an adhesive at a jobsite according to some embodiments of the present invention. Process 300 may be performed to prepare a liquid adhesive, such as the liquid adhesive described in accordance with FIG. 2 above. Process 300 may begin at operation 305 by introducing a pre-packaged quantity of adhesive additive components to a volume of a solvent. Oftentimes, the solvent may be locally sourced and/or otherwise provided separately from other adhesive components, which may reduce shipping costs and storage space requirements. For example, buckets, drums, and/or other containers of common solvents, such as acetone, xylene, alcohol-based, and/or alkyl-based adhesives may be acquired. In some embodiments, the solvents may be premeasured and poured into a mixing vessel, while in other embodiments a user may measure out a quantity of solvent into the mixing vessel. In some embodiments, the solvent may be water. In such instances, the user may measure out a predetermined volume of water from a water source, such as a faucet or hose, and pour the water into a mixing vessel.

In some embodiments, the adhesive additive components may be added from a first container. The first container may be dissolvable in some embodiments such that the entire container may be placed in the solvent to introduce the adhesive additive components to the solvent. In other embodiments, the first container may be opened and the adhesive additive components may be poured into the solvent. After the adhesive additive components are added, the solvent solution may be mixed, such as by using a stirring attachment for a drill, using a paddle mixer, manually using a stir stick, shaking the mixing vessel, and/or otherwise agitating the solvent solution.

A pre-packaged quantity of adhesive filler components may be introduced to the volume of the solvent at operation 310. In some embodiments, the adhesive filler components may be introduced to the solvent simultaneously with the adhesive additive components. For example, the adhesive filler components and the adhesive additive components may be provided within a single container. In other embodiments, the adhesive filler components may be added after the adhesive additive components, such as after the solvent solution has been mixed. By adding the adhesive additive components prior to the adhesive filler components, the adhesive filler components may be better dispersed within the solvent solution. For example, the adhesive additive components may include dispersants, that, once in solution within the solvent may enhance the ability of the adhesive filler components to disperse throughout the solvent solution. In some embodiments, the adhesive filler components may be added to the solvent all at once, while in other embodiments the adhesive filler components may be added gradually, such as by sequentially introducing a number of portions of the pre-packaged quantity of adhesive filler components to the mixing vessel. The portions may have equal amounts of adhesive filler components in some embodiments, while in other embodiments some or all of the portions may be different.

In some embodiments in which the adhesive filler components are added separately from the adhesive additive components, the adhesive filler components may be added from a second container. The second container may be dissolvable in some embodiments such that the entire container may be placed in the solvent to introduce the adhesive filler components to the solvent. In other embodiments, the second container may be opened and the adhesive filler components may be poured into the solvent. After the adhesive filler components are added, the solvent solution may be mixed to produce a liquid adhesive at operation 315, such as by using a stirring attachment for a drill, using a paddle mixer, manually using a stir stick, shaking the mixing vessel, and/or otherwise agitating the solvent solution. In some embodiments, after mixing the solvent, adhesive additive materials, and adhesive filler materials, a letdown portion of the solvent may be added to the mixing vessel and mixed with the liquid adhesive to ensure the liquid adhesive has a desired consistency and/or viscosity. Once the desired consistency and/or viscosity is achieved, the liquid adhesive may be applied to a roof structure, roofing membrane, and/or other object.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method for preparing an adhesive at a jobsite, comprising:
introducing a pre-packaged quantity of adhesive additive components to a volume of a solvent;
introducing a pre-packaged quantity of adhesive filler components to the volume of the solvent; and
mixing the volume of the solvent to disperse the adhesive additive components and the adhesive filler components within the volume of the solvent to produce an adhesive.

2. The method for preparing an adhesive at a jobsite of claim 1, further comprising:
after mixing the volume of the solvent, adding a letdown portion of the solvent to the adhesive to adjust a viscosity of the adhesive.

3. The method for preparing an adhesive at a jobsite of claim 1, further comprising:
mixing the volume of the solvent after introducing the packaged quantity of adhesive additive components and prior to introducing the pre-packaged quantity of adhesive filler components.

4. The method for preparing an adhesive at a jobsite of claim 1, wherein:
the adhesive additive components are provided in a first container; and
the adhesive filler components are provided in a second container.

5. The method for preparing an adhesive at a jobsite of claim 4, wherein:
one or both of the first container and the second container are dissolvible in the solvent such that introduction of one or both of the adhesive additive components and the adhesive filler components into the volume of the solvent comprises placing the respective container into the volume of the solvent.

6. The method for preparing an adhesive at a jobsite of claim 1, wherein:
the solvent comprises at least one solvent selected from the group consisting of water, acetone, an alcohol, and a alkyl-based solvent.

7. The method for preparing an adhesive at a jobsite of claim 1, wherein:
the adhesive additive components comprise at least one additive selected from the group consisting of a dispersant, a flocculant, a colorant, and a resin; and
the adhesive filler components comprise at least one filler selected from the group consisting of calcium carbonate, mica, and talc.

8. A method for preparing an adhesive at a jobsite, comprising:
measuring out a volume of water into a mixing vessel;
introducing a pre-packaged quantity of adhesive additive components to the mixing vessel;
introducing a pre-packaged quantity of adhesive filler components to the mixing vessel; and
mixing the water, the adhesive additive components, and the adhesive filler components to disperse the adhesive additive components and the adhesive filler components within the volume of water to produce an adhesive.

9. The method for preparing an adhesive at a jobsite of claim 8, wherein:
the mixing is done using a stir stick or a stirring attachment for a drill.

10. The method for preparing an adhesive at a jobsite of claim 8, wherein:
the mixing vessel comprises a bucket or a drum.

11. The method for preparing an adhesive at a jobsite of claim 8, wherein:
the pre-packaged quantity of adhesive additive components are introduced to the mixing vessel prior to the pre-packaged quantity of adhesive filler components.

12. The method for preparing an adhesive at a jobsite of claim 8, wherein:
the pre-packaged quantity of adhesive additive components and the pre-packaged quantity of adhesive filler components are packaged in a single container; and
the single container comprises a partition that separates the pre-packaged quantity of adhesive additive components from the pre-packaged quantity of adhesive filler components until the pre-packaged quantity of adhesive additive components and the pre-packaged quantity of adhesive filler components are introduced to the mixing vessel.

13. The method for preparing an adhesive at a jobsite of claim 8, wherein:
the pre-packaged quantity of adhesive additive components and the pre-packaged quantity of adhesive filler components are pre-measured such that one package of the pre-packaged quantity of adhesive additive components and one package of the pre-packaged quantity of adhesive filler components are used to form one mixing vessel of the adhesive.

14. The method for preparing an adhesive at a jobsite of claim 8, wherein:
introducing the pre-packaged quantity of adhesive filler components to the mixing vessel comprises sequentially introducing a plurality of portions of the pre-packaged quantity of adhesive filler components to the mixing vessel.

15. An adhesive kit, comprising:
one or more containers comprising a pre-packaged quantity of adhesive additive components and a pre-packaged quantity of adhesive filler components, wherein:
the adhesive additive components comprise at least one additive selected from the group consisting of a dispersant, a flocculant, a colorant, and a resin; and
the adhesive filler components comprise at least one mineral-based filler.

16. The adhesive kit of claim 15, further comprising:
a mixing vessel that houses the one or more containers.

17. The adhesive kit of claim 15, further comprising:
a pre-measured quantity of a solvent.

18. The adhesive kit of claim 15, wherein:
the one or more containers comprise a first container that contains the pre-packaged quantity of adhesive additive components and a second container that contains the pre-packaged quantity of adhesive filler components.

19. The adhesive kit of claim 15, wherein:
the one or more containers comprise a single container; and
the single container comprises a partition that separates the pre-packaged quantity of adhesive additive components from the pre-packaged quantity of adhesive filler components until an adhesive is formed using the pre-packaged quantity of adhesive additive components and the pre-packaged quantity of adhesive filler components.

20. The adhesive kit of claim 15, wherein:
at least one of the one or more containers is dissolvible in a solvent used to produce an adhesive.
